(19) United States
(12) Patent Application Publication
(10) Pub. No.: US 2011/0008631 A1
(43) Pub. Date: Jan. 13, 2011

(54) MULTI-PLY WEB OF FLEXIBLE MATERIAL, SUCH AS TISSUE PAPER OR NONWOVEN, AND PRODUCT, AND METHOD FOR IMPROVING THE BLEED FASTNESS OF A FLUORESCENT WHITENING AGENT OF A MULTI-PLY WEB

(75) Inventor: David Lindqvist, Molndal (SE)

Correspondence Address: YOUNG & THOMPSON, 209 Madison Street, Suite 500, Alexandria, VA, 22314, US

(73) Assignee: SCA HYGIENE PRODUCTS AB, Goteborg (SE)

(21) Appl. No.: 12/921,201

(22) PCT Filed: Mar. 7, 2008
(86) PCT No.: PCT/SE08/50255

§ 371 Date: Sep. 7, 2010

(51) Int. Cl. D21H 27/32; B32B 7/12; B32B 29/00; B32B 37/12

(52) U.S. Cl. 428/449; 428/511; 156/327

(57) ABSTRACT

A multi-ply web of flexible material, such as tissue paper or nonwoven material, includes a fluorescent whitening agent. The multi-ply web includes at least two plies being interconnected in one or more adhesive interconnection zones with an adhesive composition including polyvinyl alcohol, a polyaldehyde and an acid catalyst. The polyvinyl alcohol is cross-linked with the polyaldehyde such that the adhesive composition is water insoluble. Also described is a method for improving the bleed fastness of a fluorescent whitening agent of a multi-ply web of flexible material, which includes at least two plies being interconnected in one or more adhesive interconnection zones with an adhesive composition including polyvinyl alcohol. The method includes a step of incorporating a polyaldehyde and an acid catalyst in the adhesive composition so as to cross-link the polyvinyl alcohol with the polyaldehyde such that the adhesive composition is made water insoluble.

### TECHNICAL FIELD

The present invention relates to a multi-ply web of flexible material, such as tissue paper or nonwoven material, comprising a fluorescent whitening agent, whereby the multi-ply web comprises at least a first ply and a second ply which are interconnected in one or more adhesive interconnection zones by means of an adhesive composition comprising polyvinyl alcohol. In addition, the present invention relates to a product made from the multi-ply web according to the invention. Especially, it relates to tissue web products such as toilet and kitchen paper, paper towels, hand towels, napkins, handkerchiefs, wiping material and the like. Furthermore, the present invention relates to a method for improving the bleed fastness of a fluorescent whitening agent of a multi-ply web of flexible material, such as tissue paper or nonwoven material, comprising a fluorescent whitening agent, which multi-ply web comprises at least a first ply and a second ply which are interconnected in one or more adhesive interconnection zones by means of an adhesive composition comprising polyvinyl alcohol.

### BACKGROUND OF THE INVENTION

It is very common to laminate two or more plies of a flexible material, such as a tissue paper material or a nonwoven material, in order to produce a final multi-ply web. For example, it is very common to laminate two or more tissue plies in order to produce final tissue web products such as toilet and kitchen paper, paper towels, hand towels, napkins, handkerchiefs, wiping material and the like. Through lamination, a more flexible and softer tissue web product is obtained as compared to if one single ply with a corresponding thickness and basis weight had been produced. The absorbent capacity and the bulk are also improved.

The lamination of two or more plies of a flexible material is often carried out by means of gluing, i.e. the plies are interconnected by means of glue in one or more adhesive interconnection zones. Many types of glue utilized today for lamination are based on polyvinyl alcohol, which provides good runnability and ply bonding.

Furthermore, the flexible material of the plies laminated to a multi-ply web may comprise fluorescent whitening agents (FWAs), which are also called, for example, optical brighteners (OBs), optical brightening agents (OBAs), fluorescent brightening agents (FBAs), optical bleachers and fluorescent bleachers.

It is very common to utilize FWAs in order to improve the brightness of a flexible material, such as a tissue paper or a nonwoven material. FWAs are substances that absorb light in the invisible ultraviolet region of the spectrum and re-emit light in the blue region. The emission of blue light creates a whitening effect and offsets any yellow cast of a substrate. Examples of commonly used types of FWAs for improving the brightness of tissue paper are derivatives of diamino-stilbene-sulphonic acids having different numbers of sulphonate groups.

FWAs may be added to the pulp during the pulping stage. Alternatively, they may be applied to the surface of the flexible material at the size press or by coating. Furthermore, since it is common to utilize FWAs in flexible materials and since it is difficult to remove FWAs from flexible materials in recycling processes, FWAs are often contained in recycled flexible materials, i.e. in flexible materials comprising recycled pulp.

One of the criteria for product safety is bleed fastness of FWAs. However, polyvinyl alcohol acts as a carrier for FWAs. Thus, in a multi-ply web comprising plies which are interconnected by means of an adhesive composition comprising polyvinyl alcohol in adhesive interconnection zones, FWAs may be dissolved by polyvinyl alcohol in the adhesive interconnection zones. Furthermore, since the polyvinyl alcohol utilized for lamination of plies of multi-ply webs is water soluble, the dissolved FWAs may—together with polyvinyl alcohol—bleed from the multi-ply web when polyvinyl alcohol is contacted by water, another aqueous liquid or the like, in use of the multi-ply web.

Consequently, when plies of a flexible material comprising FWAs are laminated by means of an adhesive composition comprising polyvinyl alcohol to a final multi-ply web, the bleed fastness of FWAs may be reduced in the produced multi-ply web due to the fact that FWAs are dissolved by polyvinyl alcohol and due to the fact that the polyvinyl alcohol is water soluble. More specifically, the bleed fastness of FWAs may then be reduced in the adhesive interconnection zone(s) of the produced multi-ply web. The risk of possible bleeding of FWAs from such multi-ply webs, i.e. from the adhesive interconnection zone(s) comprising polyvinyl alcohol of such multi-ply webs, must be reduced.

One way to improve the bleed fastness of FWAs in adhesive interconnection zone(s), i.e. to reduce the risk of possible bleeding or to reduce bleeding of FWAs from adhesive interconnection zone(s), of multi-ply webs of a flexible material, in which plies are interconnected by an adhesive composition comprising polyvinyl alcohol in the adhesive interconnection zone(s), is to utilize low amounts of the adhesive composition comprising polyvinyl alcohol. However, there is then a risk of obtaining poor ply bonding.

Another way to improve the bleed fastness of FWAs in adhesive interconnection zone(s) of multi-ply webs of a flexible material, in which plies are interconnected by an adhesive composition comprising polyvinyl alcohol in the adhesive interconnection zone(s), is to use polyvinyl alcohol with lower solubility. However, polyvinyl alcohol with low solubility may be difficult to apply on a ply of a flexible material and may also get stuck on devices or machines during the production process.

Thus, there is still a need for a way of improving the bleed fastness of FWAs of multi-ply webs of a flexible material, in which plies are interconnected in one or more adhesive interconnection zones by an adhesive composition comprising polyvinyl alcohol, which does not involve the above mentioned drawbacks. Furthermore, there is still a need for an improved multi-ply web of flexible material comprising FWAs, whereby plies are interconnected in one or more adhesive interconnection zones by means of an adhesive composition comprising polyvinyl alcohol, whereby the bleed fastness of FWAs of the multi-ply web is improved and whereby the above-mentioned drawbacks are avoided.

### SUMMARY OF THE INVENTION

Accordingly, one object of the present invention is to provide an improved multi-ply web of flexible material, such as tissue paper or nonwoven material, said flexible material comprising a fluorescent whitening agent, whereby the multi-ply web comprises at least a first ply and a second ply which are interconnected in one or more adhesive interconnection zones by means of an adhesive composition comprising polyvinyl alcohol. This object is achieved by the fact that the adhesive composition further comprises a polyaldehyde and an acid catalyst, whereby said polyvinyl alcohol is cross-linked with said polyaldehyde such that said adhesive composition is water insoluble.

Another object of the present invention is to provide an improved method for improving the bleed fastness of a fluorescent whitening agent of a multi-ply web of flexible material, such as tissue paper or nonwoven material, comprising a fluorescent whitening agent, said multi-ply web comprising at least a first ply and a second ply being interconnected in one or more adhesive interconnection zones by means of an adhesive composition comprising polyvinyl alcohol.

This object is achieved by the fact that the method comprises a step of incorporating a polyaldehyde and an acid catalyst in said adhesive composition comprising polyvinyl alcohol so as to cross-link said polyvinyl alcohol with said polyaldehyde such that said adhesive composition is made water insoluble.

Preferred embodiments are listed in the dependent claims.

Still other objects and features of the present invention will become apparent from the following detailed description and from the claims.

### DETAILED DESCRIPTION OF PREFERRED EMBODIMENTS

As mentioned previously, the invention concerns a multi-ply web of flexible material. The term “multi-ply web” is herein to be understood as a web comprising two or more plies. Thus, the multi-ply web according to the invention may be, for example, a two-ply web or a three-ply web.

The term “flexible material” is herein to be understood to include tissue paper materials, nonwoven materials, and materials being a mixture of tissue paper and nonwoven materials.

The term “tissue paper” is herein to be understood as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³. Moist tissue paper webs are usually dried against one or more heated rolls. A method which is commonly used for tissue paper is so-called Yankee drying. At Yankee drying the moist paper web is pressed against a steam-heated Yankee cylinder, which can have a very large diameter. The paper web is usually creped against the Yankee cylinder. Another drying method is so-called through-air-drying (TAD). In this method the paper is dried by means of hot air blown through the moist paper web, often without a preceding wet pressing. In connection with the TAD drying, the patterned structure of the drying fabric is transferred to the paper web. This structure is also essentially maintained in the wet condition of the paper, since it has been imparted to the wet paper web.

International patent application no. WO9934055 discloses a method for producing an impulse dried paper, especially tissue paper, having a three-dimensional pattern, said paper having high bulk and softness. Impulse drying involves that the moist paper web is passed through the press nip between a press roll or press shoe and a heated roll, which is heated to such a high temperature that a quick and strong steam generation occurs in the interface between the moist paper web and the heated roll. The three-dimensional embossment pattern is accomplished by means of a pattern provided on the heated roll. The counter means, for example a press felt, against which the paper is pressed in connection with the simultaneous impulse drying and shaping, has a non-rigid surface.

The tissue paper in the present invention may be any type of tissue paper. The tissue paper may be creped or non-creped. The creping may take place in wet or dry condition. It may further be foreshortened by any other methods, such as so-called rush transfer between wires.

The fibres contained in the tissue paper are mainly pulp fibres from chemical pulp, mechanical pulp, thermo mechanical pulp, chemo mechanical pulp and/or chemo thermo mechanical pulp (CTMP). The tissue paper may also contain other types of fibres enhancing e.g. strength, absorption or softness of the paper. These fibres may be made from regenerated cellulose or synthetic material such as polyolefins, polyesters, polyamides etc.

The term “nonwoven” is applied to a wide range of products which in term of their properties are located between the groups of paper and cardboard on the one hand and textiles on the other hand. As regards nonwovens a large number of extremely varied production processes are used, such as airlaid, wetlaid, spunlaced, spunbond, meltblown techniques etc. Nonwovens represent flexible porous fabrics that are not produced by the classical methods of weaving or knitting, but by intertwining and/or by cohesive and/or adhesive bonding of typical synthetic textile fibres, which may for example be present in the form of endless fibres or fibres prefabricated with an endless length, as synthetic fibres produced in situ or in the form of staple fibres. Alternatively, they may be made from natural fibres or from blends of synthetic fibres and natural fibres.

The flexible material of the multi-ply web according to the invention may be recycled flexible material, newly-produced material or a combination thereof.

Furthermore, the flexible material of the multi-ply web according to the invention comprises one or more fluorescent whitening agents (FWA), which are also called, for example, optical brighteners (OBs), optical brightening agents (OBAs), fluorescent brightening agents (FBAs), optical bleachers and fluorescent bleachers. A fluorescent whitening agent comprised in the flexible material of the multi-ply web according to the invention may be any fluorescent whitening agent suitable to utilize in order to improve the brightness of tissue paper or nonwoven materials. For example, it may be a derivative of a diamino-stilbene-sulphonic acid, such as a derivative of 4,4′-diaminostilbene-2,2′-disulphonic acid. Examples of commonly used derivatives are di-, tetra-, and hexasulphonated derivatives of 4,4′-diaminostilbene-2,2′-disulphonic acid. Furthermore, a fluorescent whitening agent comprised in the flexible material of the multi-ply web according to the invention may be of a type that binds to the fibers of the flexible material or may be of a type that is coated onto the flexible material. In case the flexible material comprises two or more FWAs, they may be of different types.

In case the flexible material of the multi-ply web according to the invention comprises recycled flexible material, the fluorescent whitening agent(s) may be comprised in the flexible material due to the fact that the recycled flexible material comprises one or more fluorescent whitening agents. As mentioned above, FWAs are difficult to remove in recycling processes and, thus, recycled flexible materials often comprise FWAs. Alternatively, in case the flexible material is constituted by newly-produced material, the fluorescent whitening agent(s) may be comprised in the flexible material due to the fact that the fluorescent whitening agent(s) is/are added to the flexible material during production of the multi-ply web. As mentioned above, FWAs may be added to the pulp during the pulping stage or may be applied to the surface of the flexible material at the size press or by coating.

In a first embodiment, the multi-ply web according to the invention is a two-ply web of flexible material. The two-ply web comprises a first ply and a second ply which are interconnected, i.e. laminated, in one or more adhesive interconnection zones by means of an adhesive composition comprising polyvinyl alcohol.

The term “polyvinyl alcohol” is herein to be understood to include polyvinyl alcohol as well as other structures in which there are certain changes compared to the structure of polyvinyl alcohol, but which have the same “overall structure” as polyvinyl alcohol. However, the term “polyvinyl alcohol” is herein intended to denote forms of polyvinyl alcohol being water soluble. For example, polyvinyl alcohol may be partially, intermediate, fully or super hydrolyzed. Grades of polyvinyl alcohol being partially, intermediate, fully or super hydrolyzed are included within the term “polyvinyl alcohol” herein. For example, polyvinyl alcohol may be e.g. 70-100 mol % hydrolyzed. In addition, grades of polyvinyl alcohol having different molecular weights are also included within the term “polyvinyl alcohol” herein. Polyvinyl alcohol is based on vinyl alcohol monomers or derivatives thereof. Polyvinyl alcohol is usually produced by hydrolyzing polyvinyl acetate to polyvinyl alcohol.

As mentioned above, adhesive compositions based on polyvinyl alcohol provide good runnability and ply bonding when used for lamination of plies to a multi-ply web, but polyvinyl alcohol acts as a carrier for FWAs and is water soluble. Thus, in a multi-ply web comprising plies which are interconnected in adhesive interconnection zones by means of an adhesive composition comprising polyvinyl alcohol, FWAs may be dissolved by polyvinyl alcohol in the adhesive interconnection zones. Furthermore, since polyvinyl alcohol is water soluble, the dissolved FWAs may—together with polyvinyl alcohol—bleed from the multi-ply web when polyvinyl alcohol is contacted by water, another aqueous liquid or the like, in use of the multi-ply web. Thereby, polyvinyl alcohol counteracts the bleed fastness of FWAs of a multi-ply web of flexible material. More specifically, polyvinyl alcohol counteracts the bleed fastness of FWAs in the adhesive interconnection zones comprising polyvinyl alcohol

However, it has now surprisingly been found that through incorporation of a polyaldehyde and an acid catalyst in the adhesive composition comprising polyvinyl alcohol so as to cross-link polyvinyl alcohol with the polyaldehyde (i.e. to achieve a cross-linking of polyvinyl alcohol chains by means of the polyaldehyde) such that the adhesive composition is made water insoluble, the bleed fastness of FWAs of a multi-ply web is improved. Thus, the incorporated amounts of polyaldehyde and acid catalyst are selected such that the cross-linking of the polyvinyl alcohol with the polyaldehyde is performed to such a degree that the adhesive composition is made water insoluble. The incorporated polyaldehyde works as a cross-linking agent, i.e. it forms cross-links between polyvinyl alcohol chains. The acid catalyst catalyzes the cross-linking reaction, i.e. the cross-linking reaction is an acid catalyzed reaction. In the present application, the adhesive composition is deemed to be water insoluble if it produces a “4” or a “5” in the FWA bleed fastness tests described herein, i.e. in Examples 2-3 in the Experimental section. The water solubility/insolubility is determined at or around room temperature, i.e. around 20-23° C.

The fact that the adhesive composition is made water insoluble implies that the bleeding of the adhesive composition from the multi-ply web when contacted by water, another aqueous liquid or the like, in use of the multi-ply web is eliminated or at least reduced. Thereby, bleeding of FWAs—together with the adhesive composition—is eliminated or at least reduced. In other words, the risk of possible bleeding of FWAs from the adhesive interconnection zone(s) comprising polyvinyl alcohol is thereby eliminated or at least reduced, i.e. the bleed fastness of FWAs of the adhesive interconnection zones comprising polyvinyl alcohol, and thus of the multi-ply web, is thereby improved.

Without wishing to be bound to any theory, there might be further reactions fixing the FWA in the multi-ply web according to the invention. In case the FWA comprises a sulphonic acid, the FWA might also be fixed by condensation reactions between the sulphonic acid in the FWA and the aldehyde in the polyaldehyde.

Accordingly, the adhesive composition, by which the first and second plies are laminated in the first embodiment of the multi-ply web according to the invention, further comprises a polyaldehyde and an acid catalyst. Thus, the adhesive composition, by which the first and second plies are laminated in the first embodiment of the multi-ply web according to the invention, comprises polyvinyl alcohol, a polyaldehyde and an acid catalyst. The polyvinyl alcohol is cross-linked with the polyaldehyde such that the adhesive composition is water insoluble.

For example, the adhesive composition, by which the first and second plies are laminated in the first embodiment of the multi-ply web according to the invention, may comprise any of the polyvinyl alcohol adhesive compositions Kappasil 250, Kappasil 260, Kappasil 260-1 supplied by Kapp-Chemie GmbH, Germany; Gummi 88Z3 supplied by Türmerleim GmbH, Germany; and Aquagrip TL 220, Aquagrip TLX222 supplied by Bostik SA, France, and a polyaldehyde and an acid catalyst. Alternatively, the adhesive composition, by which the first and second plies are laminated in the first embodiment of the multi-ply web according to the invention, may comprise Kappasil P4/447 supplied by Kapp-Chemie GmbH, Germany, and a polyaldehyde and an acid catalyst.

The polyaldehyde incorporated in the adhesive composition may be any polyaldehyde that may cross-link chains of polyvinyl alcohol so as to make the adhesive composition water insoluble or to reduce the water solubility thereof. The term “polyaldehyde” is herein intended to encompass aldehydes having two or more aldehyde groups. For example, the polyaldehyde may be a dialdehyde. One preferred dialdehyde is glyoxal or glyoxal hydrate. For example, one glyoxal product that may be utilized is Glyoxal 40% supplied by BASF, Ludwigshafen; Germany (art. no. 50509674). Alternatively, the polyaldehyde may be polyaldehyde dextran. The polyaldehyde dextran may, for example, be produced by hydrolyzing dialdehyde starch (DAS) with sulphuric acid during heating. For example, DAS 100 (Lyckeby Industrial AB, Kristianstad, Sweden) may be hydrolyzed in about 25% sulphuric acid in about 95° C. One example of such a production of polyaldehyde dextran is found in Example 3 in the Experimental section below.

The acid catalyst incorporated in the adhesive composition may be any suitable acid catalyst that may work as a catalyst for a cross-linking reaction in which polyvinyl alcohol chains are cross-linked with a polyaldehyde. The acid catalyst may, for example, be selected from the group consisting of: polyaluminium chloride, polyferric sulphate, polyferric chloride, ferric chloride sulphate, polysilicate aluminium sulphate, polyferric silicate sulphate, polyaluminium silicate chloride, polyaluminium ferric silicate chloride, polyferric chloride sulphate, and polyaluminium ferric chloride. Alternatively, sulphuric acid could be utilized as acid catalyst.

One example of a preferred combination of a polyaldehyde and an acid catalyst incorporated in the adhesive composition is glyoxal and polyaluminium chloride.

The adhesive composition may comprise polyvinyl alcohol, one polyaldehyde and one acid catalyst. Alternatively, it may comprise polyvinyl alcohol, more than one polyaldehyde (i.e. at least two different polyaldehydes) and one acid catalyst. As another alternative, it may comprise polyvinyl alcohol, one polyaldehyde and more than one acid catalyst (i.e. at least two different acid catalysts). As a further alternative, it may comprise polyvinyl alcohol, more than one polyaldehyde and more than one acid catalyst. In still another alternative, the adhesive composition comprises polyvinyl alcohol, at least one polyaldehyde, at least one acid catalyst and any other suitable constituents. For example, the adhesive composition may comprise at least one constituent selected from the group consisting of: a dye, a viscosity modifier, an anti-foaming agent and a preserving agent. In addition, the adhesive composition may comprise a solvent. Water is preferred as solvent. Furthermore, the adhesive composition may optionally comprise polyvinyl acetate so as to modify the viscosity thereof.

The adhesive composition may comprise 2-12% w/w polyvinyl alcohol, preferably 4-6% w/w polyvinyl alcohol, after the step of incorporating a polyaldehyde and an acid catalyst into the adhesive composition but before any cross-linking has occurred. Furthermore, the adhesive composition may comprise 0.05-2.00% w/w polyaldehyde, preferably 0.10-1.00% w/w polyaldehyde, after the step of incorporating a polyaldehyde and an acid catalyst into the adhesive composition but before any cross-linking has occurred. In one example the adhesive composition comprises 0.10-0.50% w/w glyoxal, preferably 0.10-0.30% w/w glyoxal, after the step of incorporating a polyaldehyde and an acid catalyst into the adhesive composition but before any cross-linking has occurred. In another example, the adhesive composition comprises 0.10-1.00% w/w polyaldehyde dextran, preferably 0.30-0.70% w/w polyaldehyde dextran, after the step of incorporating a polyaldehyde and an acid catalyst into the adhesive composition but before any cross-linking has occurred. Furthermore, the adhesive composition may comprise e.g. 0.30-20.00% w/w acid catalyst, preferably 0.30-15.00% w/w acid catalyst, after the step of incorporating a polyaldehyde and an acid catalyst into the adhesive composition but before any cross-linking has occurred. In one example, the adhesive composition comprises 5.00-15.00% w/w polyaluminium chloride and in another example the adhesive composition comprises 0.30-1.00% w/w sulphuric acid after the step of incorporating a polyaldehyde and an acid catalyst into the adhesive composition but before any cross-linking has occurred. The concentrations of substances provided herein are expressed in weight percentage (% w/w). Unless otherwise stated, these concentrations are measured as dry weights.

In a second embodiment, the multi-ply web according to the invention is a three-ply web of flexible material. The second embodiment corresponds to the first embodiment except for the fact that the multi-ply web comprises one further ply, i.e. it is a three-ply web instead of a two-ply web. The three-ply web comprises a first ply, a second ply and a third ply, whereby the second ply is provided as a middle ply. The first and second plies of the second embodiment correspond to the first and second plies of the first embodiment. However, the second ply and the third ply are also interconnected, i.e. laminated, in one or more adhesive interconnection zones by means of the adhesive composition comprising polyvinyl alcohol, at least one polyaldehyde and at least one acid catalyst described in connection with the first embodiment.

In a third embodiment, the multi-ply web according to the invention is a three-ply web. The third embodiment corresponds to the second embodiment except for the fact that the second and third plies are not interconnected by means of the adhesive composition comprising polyvinyl alcohol, at least one polyaldehyde and at least one acid catalyst. Instead the second and third plies are interconnected by means of any other suitable adhesive composition or by means of only mechanical embossing, whereby the mechanical joining of the plies occurs in the embossing sites.

In further embodiments, the multi-ply web according to the invention comprises more than three plies, whereby all plies are interconnected by means of the adhesive composition comprising polyvinyl alcohol, at least one polyaldehyde and at least one acid catalyst described in connection with the first embodiment. Thus, in these embodiments each pair of two adjacent plies are interconnected by means of the mentioned adhesive composition.

In alternative embodiments, the multi-ply web according to the invention comprises more than three plies, whereby only some of the plies are interconnected by means of the adhesive composition comprising polyvinyl alcohol, at least one polyaldehyde and at least one acid catalyst described in connection with the first embodiment whereas the other plies are interconnected by means of any other suitable adhesive composition or by means of only mechanical embossing.

The flexible material of any of the above embodiments of the multi-ply web may be a tissue paper to which a wet strength agent has been added.

Furthermore, the present invention relates to a method for improving the bleed fastness of a fluorescent whitening agent of a multi-ply web of flexible material, such as tissue paper or nonwoven material, comprising a fluorescent whitening agent, whereby the multi-ply web comprises at least a first ply and a second ply being interconnected in one or more adhesive interconnection zones by means of an adhesive composition comprising polyvinyl alcohol. According to the invention, the method comprises a step of incorporating a polyaldehyde and an acid catalyst in the adhesive composition comprising polyvinyl alcohol so as to cross-link the polyvinyl alcohol with the polyaldehyde such that the adhesive composition is made water insoluble.

The method according to the invention may be applied for improving the bleed fastness of FWAs of a two-ply web comprising a first and a second ply being interconnected in one or more adhesive interconnection zones by means of an adhesive composition comprising polyvinyl alcohol. Alternatively, the method according to the invention may be applied for improving the bleed fastness of FWAs of a three-ply web comprising a first ply, a second ply and a third ply, whereby the first and second plies are interconnected in one or more adhesive interconnection zones by means of an adhesive composition comprising polyvinyl alcohol and the second and third plies are interconnected in one or more adhesive interconnection zones by means of the adhesive composition comprising polyvinyl alcohol. In another alternative, the method according to the invention may be applied for improving the bleed fastness of FWAs of a three-ply web comprising a first ply, a second ply and a third ply, whereby the first and second plies are interconnected in one or more adhesive interconnection zones by means of an adhesive composition comprising polyvinyl alcohol and whereby the second and third plies are interconnected by means of any other suitable adhesive composition or by means of only mechanical embossing. In still another alternative, the method according to the invention may be applied for improving the bleed fastness of FWAs of a multi-ply web comprising more than three plies, whereby all or only some of the plies are interconnected by means of an adhesive composition comprising polyvinyl alcohol.

By means of the method according to the invention, the polyvinyl alcohol of the adhesive composition is cross-linked with a polyaldehyde, i.e. a cross-linking of polyvinyl alcohol chains is obtained by means of the polyaldehyde working as a cross-linking agent. The acid catalyst catalyzes the cross-linking reaction, i.e. the cross-linking reaction is an acid catalyzed reaction. Furthermore, by means of the method according to the invention, the polyvinyl alcohol is cross-linked with the polyaldehyde such that the adhesive composition is made water insoluble. Thus, the incorporated amounts of polyaldehyde and acid catalyst are selected such that the cross-linking of the polyvinyl alcohol with the polyaldehyde is performed to such a degree that the adhesive composition is made water insoluble. In the present application, the adhesive composition is deemed to be water insoluble if it produces a “4” or a “5” in the FWA bleed fastness tests described herein, i.e. in Examples 2-3 in the Experimental section. The water solubility/insolubility is determined at or around room temperature, i.e. around 20-23° C.

The fact that the adhesive composition is made water insoluble implies that the bleeding of the adhesive composition from the multi-ply web when contacted by water, another aqueous liquid or the like, in use of the multi-ply web is eliminated or at least reduced. Thereby, bleeding of FWAs—together with the adhesive composition—is eliminated or at least reduced. In other words, the risk of possible bleeding of FWAs from the adhesive interconnection zone(s) comprising polyvinyl alcohol is thereby eliminated or at least reduced, i.e. the bleed fastness of FWAs of the adhesive interconnection zone(s), and thus of the multi-ply web, is thereby improved.

Without wishing to be bound to any theory, there might be further reactions fixing the FWA in the multi-ply web according to the invention. In case the FWA comprises a sulphonic acid, the FWA might also be fixed by condensation reactions between the sulphonic acid in the FWA and the aldehyde in the polyaldehyde.

By the expression that “a polyaldehyde and an acid catalyst are incorporated in an adhesive composition comprising polyvinyl alcohol” is meant that a polyaldehyde and an acid catalyst are added to an adhesive composition comprising polyvinyl alcohol. Alternatively, an adhesive composition comprising polyvinyl alcohol may be added to a composition comprising a polyaldehyde and an acid catalyst. In another alternative, an adhesive composition comprising polyvinyl alcohol may be added to a polyaldehyde, after which the produced composition is added to an acid catalyst. In still another alternative, an adhesive composition comprising polyvinyl alcohol may be added to an acid catalyst, after which the produced composition is added to a polyaldehyde.

For example, the step of incorporating a polyaldehyde and an acid catalyst in the adhesive composition may be performed before plies of the multi-ply web are interconnected by means of the adhesive composition during production of the multi-ply web. Preferably, a polyaldehyde and an acid catalyst are incorporated in an adhesive composition comprising polyvinyl alcohol before application of the adhesive composition on a ply of flexible material for interconnection of that ply with another ply. Alternatively, a polyaldehyde and an acid catalyst may be incorporated in an adhesive composition comprising polyvinyl alcohol after application of the adhesive composition on a ply but before that ply is interconnected with another ply by means of the adhesive composition.

However, the step of incorporating a polyaldehyde and an acid catalyst in the adhesive composition could also be performed after a ply has been provided with the adhesive composition comprising polyvinyl alcohol and has been interconnected with another ply by means of the adhesive composition. Thus, a polyaldehyde and an acid catalyst may alternatively be incorporated into an adhesive composition comprising polyvinyl alcohol already present in adhesive interconnection zones in a multi-ply web and working as an interconnecting agent.

The cross-linking occurs preferably during drying of the adhesive composition.

The method according to the invention may further comprise a step of heating the adhesive composition to 65-110° C. after incorporation of the polyaldehyde and the acid catalyst in the adhesive composition. The step of heating is performed in order to promote the cross-linking of polyvinyl alcohol with the polyaldehyde. Preferably, the step of heating is performed when the adhesive composition comprising polyvinyl alcohol, a polyaldehyde and an acid catalyst is present on a ply of flexible material. Alternatively, it may, however, be performed before the adhesive composition comprising polyvinyl alcohol, a polyaldehyde and an acid catalyst is applied on a ply. Heating can be obtained by any suitable means commonly utilized in the art, such as e.g. infrared (IR) heating or heating by means of hot air. The step of heating may e.g. be performed during the time required for evaporating water remaining in the adhesive composition.

For example, the adhesive composition may comprise any of the polyvinyl alcohol adhesive compositions Kappasil 250, Kappasil 260, Kappasil 260-1 supplied by Kapp-Chemie GmbH, Germany; Gummi 88Z3 supplied by Türmerleim GmbH, Germany; and Aquagrip TL 220, Aquagrip TLX222 supplied by Bostik SA, France, into which a polyaldehyde and an acid catalyst are incorporated. Alternatively, the adhesive composition may comprise Kappasil P4/447 supplied by Kapp-Chemie GmbH, Germany, into which a polyaldehyde and an acid catalyst are incorporated.

The polyaldehyde incorporated in the adhesive composition may be any polyaldehyde that may cross-link chains of polyvinyl alcohol so as to make the adhesive composition water insoluble or to reduce the water solubility thereof. For example, the polyaldehyde may be a dialdehyde. One preferred dialdehyde is glyoxal or glyoxal hydrate. For example, one glyoxal product that may be utilized is Glyoxal 40% supplied by BASF, Ludwigshafen; Germany (art. no. 50509674). Alternatively, the polyaldehyde may be polyaldehyde dextran. The polyaldehyde dextran may, for example, be produced by hydrolyzing dialdehyde starch (DAS) with sulphuric acid during heating. For example, DAS 100 (Lyckeby Industrial AB, Kristianstad, Sweden) may be hydrolyzed in about 25% sulphuric acid in about 95° C.

The acid catalyst incorporated in the adhesive composition may be any suitable acid catalyst that may work as a catalyst for a cross-linking reaction in which polyvinyl alcohol chains are cross-linked with a polyaldehyde. The acid catalyst may, for example, be selected from the group consisting of: polyaluminium chloride, polyferric sulphate, polyferric chloride, ferric chloride sulphate, polysilicate aluminium sulphate, polyferric silicate sulphate, polyaluminium silicate chloride, polyaluminium ferric silicate chloride, polyferric chloride sulphate, and polyaluminium ferric chloride. Alternatively, sulphuric acid could be utilized as acid catalyst. However, sulphuric acid is very corrosive. Thus, other acid catalysts, such as e.g. polyaluminium chloride, may be more suitable to utilize in production equipments.

For example, the adhesive composition may comprise 2-12% w/w polyvinyl alcohol, preferably 4-6% w/w polyvinyl alcohol, after the step of incorporating a polyaldehyde and an acid catalyst into the adhesive composition but before any cross-linking has occurred. Furthermore, the adhesive composition may comprise 0.05-2.00% w/w polyaldehyde, preferably 0.10-1.00% w/w polyaldehyde, after the step of incorporating a polyaldehyde and an acid catalyst into the adhesive composition but before any cross-linking has occurred. In one example, the adhesive composition comprises 0.10-0.50% w/w glyoxal, preferably 0.10-0.30% w/w glyoxal, after the step of incorporating a polyaldehyde and an acid catalyst into the adhesive composition but before any cross-linking has occurred. In another example, the adhesive composition comprises 0.10-1% w/w polyaldehyde dextran, preferably 0.30-0.70% w/w polyaldehyde dextran, after the step of incorporating a polyaldehyde and an acid catalyst into the adhesive composition but before any cross-linking has occurred. Furthermore, the adhesive composition may comprise e.g. 0.30-20.00% w/w acid catalyst, preferably 0.30-15.00% w/w acid catalyst, after the step of incorporating a polyaldehyde and an acid catalyst into the adhesive composition but before any cross-linking has occurred. In one example, the adhesive composition comprises 5.00-15.00% w/w polyaluminium chloride and in another example the adhesive composition comprises 0.30-1.00% w/w sulphuric acid after the step of incorporating a polyaldehyde and an acid catalyst into the adhesive composition but before any cross-linking has occurred. The concentrations of substances provided herein are expressed in weight percentage (% w/w). Unless otherwise stated, these concentrations are measured as dry weights.

One example of a preferred combination of a polyaldehyde and an acid catalyst to be incorporated in the adhesive composition is glyoxal and polyaluminium chloride. Furthermore, the adhesive composition may optionally comprise at least one constituent selected from the group consisting of: a dye, a viscosity modifier, an anti-foaming agent and a preserving agent. In addition, the adhesive composition may comprise a solvent. Water is preferred as solvent. Furthermore, the adhesive composition may optionally comprise polyvinyl acetate so as to modify the viscosity thereof.

The inventive method for improving the bleed fastness of a fluorescent whitening agent of a multi-ply web of flexible material may be included in a method for producing a multi-ply web of flexible material. Thus, a method for producing a multi-ply web of flexible material according to the present invention may comprise, for example, the following steps:
incorporating a polyaldehyde and an acid catalyst in an adhesive composition comprising polyvinyl alcohol in accordance with the above described;
providing at least a first ply and a second ply of flexible material, such as tissue paper or nonwoven material;
applying said adhesive composition to at least one of said plies in one or more zones; and
interconnecting said plies by means of said adhesive composition.

Alternatively, the method for producing a multi-ply web of flexible material according to the present invention may comprise, for example, the following steps:
providing at least a first ply and a second ply of flexible material, such as tissue paper or nonwoven material;
applying an adhesive composition comprising polyvinyl alcohol to at least one of said plies in one or more zones;
incorporating a polyaldehyde and an acid catalyst in said adhesive composition comprising polyvinyl alcohol in accordance with the above described; and
interconnecting said plies by means of said adhesive composition.

The method for producing a multi-ply web of flexible material according to the invention may further comprise a step of heating the adhesive composition to 65-110° C. after incorporation of the polyaldehyde and the acid catalyst in the adhesive composition. The step of heating is performed in order to promote the cross-linking of polyvinyl alcohol with the polyaldehyde.

During production of the multi-ply web according to the invention, the adhesive composition comprising polyvinyl alcohol, at least one polyaldehyde and at least one acid catalyst may be provided on one ply, after which that ply is joined (i.e. interconnected) with another ply or other plies in, for example, a press nip between two rolls. The adhesive composition may be applied all over a ply or only in one or more regions of a ply, or only along the edges of a ply so as to provide one or more adhesive interconnection zones. For example, the adhesive composition may be applied in one or more dots and/or one or more lines. The adhesive composition may also be applied in a predetermined pattern on a ply. For example, it may be applied in continuous lines forming a network. Any suitable known methods for application of glue on one ply of flexible material and joining that ply with another ply or other plies of flexible material may be utilized in production of the multi-ply web according to the invention. One example of a typical glue concentration is 0.05-0.2 g/m² (dry weight) in a multi-ply tissue product. Furthermore, the adhesive composition may also be applied on at least one side of each ply of a multi-ply web according to the invention before lamination. Examples of suitable methods for application of the adhesive composition are flexoprinting and application during embossing lamination.

In case the adhesive composition is provided in discrete sites, such as dots or lines, the plies laminated with the adhesive composition are free and not attached to each other between the sites. Thus, empty spaces are created between the sites which increase the bulk and absorption capacity of the material, properties that are important for e.g. soft paper.

Furthermore, before the plies are laminated to the multi-ply web according to the invention they may be smooth or may have a three-dimensional structure provided earlier in the production process, for example during forming, dewatering and/or drying of the plies. A three-dimensional structure may also be provided by embossing the dry plies before lamination. The laminated multi-ply product may also be embossed after the lamination process.

The plies may be embossed by any suitable known embossing technique. It is known through, for example, EP-A-796 727 to first emboss two paper plies in a three-dimensional structure with alternating raised and recessed portions, after which glue is applied to one of the plies and the two plies are joined in a press nip between two embossing rolls, so that the raised portions of the respective plies are glued to each other. A similar embossing procedure is shown in EP-A-738 588, according to which the glue also has a colouring effect.

In WO 95/08671 there is enclosed an example of so-called nested embossing, in which the two individually embossed plies are combined and joined with the raised portions of one ply nesting into the recessed portions of the opposite ply.

Through U.S. Pat. No. 5,443,889 there is known a procedure for laminating two paper plies, which are fed over a pattern roll each, said pattern rolls having alternating raised and recessed portions and where glue is applied to one ply while this is led over the roll. The two paper plies are then glued together in a nip between the two pattern rolls, which are in register with each other so that a joining and compression of the paper plies occurs in a pattern corresponding to the raised portions of the pattern rolls.

Three or more plies may of course also be embossed and laminated with the methods described above.

Any suitable combination of different embossing patterns for the different plies may be utilized. Multi-ply webs having different structures on opposite sides may be created if the two outer plies have different embossing structures, such as one coarser side and one smoother side. So-called microquilted embossing patterns may also be used. One or more plies may further be unembossed. In the case of a two-ply web, a two-sided web is obtained if one ply is embossed and the other is unembossed or has a different embossing structure.

However, the embossing patterns used for the different plies may also be the same. In this case the plies may be embossed jointly and then separated from each other before being laminated. They may also be separately embossed before lamination.

Different kinds of flexible material with different properties with respect to absorption capacity, basis weight, manufacturing technique, fiber composition, chemical additives may be used in the different plies.

The present invention relates also to a multi-ply web of flexible material obtained by means of the method of improving the bleed fastness of a fluorescent whitening agent of a multi-ply web of flexible material according to the invention or by means of the method for producing a multi-ply web of flexible material according to the invention.

The multi-ply web according to the present invention described above and the multi-ply web of flexible material obtained by any of the above methods, respectively, may be converted to any desired product of web-shaped material, such as toilet paper, kitchen paper, napkins, serviettes, handkerchiefs, paper towels, towels, wipes, different types of cloths, make-up removal towels, facial tissue, cosmetic tissue, baby wipes, kitchen towels, kitchen wipes, cleaning wipes, industrial wiping material or any other wiping or personal hygiene material. Furthermore, the multi-ply web according to the present invention and the multi-ply web of flexible material obtained by any of the above methods, respectively, may be converted to, for example, a rolled or folded product. Thus, the present invention relates also to a product, such as a roll, folded towel, wipe, handkerchief, napkin, and the like, of web-shaped material, whereby the web-shaped material is the multi-ply web according to the invention or the multi-ply web of flexible material obtained by any of the above methods. The web-shaped material of such a product may be e.g. a tissue paper to which a wet strength agent has been added. Furthermore, the web-shaped material of such a product may be e.g. tissue paper.

### EXPERIMENTAL

### Example 1

### Objective

The objective of Example 1 was to test the FWA bleed fastness of simulated two-ply products (i.e. simulated products of a multi-ply web), in which the plies were interconnected by means of an adhesive composition comprising polyvinyl alcohol (but no polyaldehyde and no acid catalyst).

### Materials and Methods

In Example 1 recycled dry creped tissue paper made from a raw material containing high amounts of FWAs was utilized for preparing simulated two-ply tissue products. The paper basis weight was 20 gsm. In order to obtain a measure of the content of FWAs in the paper, i.e. to confirm that the paper really contained high amounts of FWAs, brightness measurements were performed on two stacks of paper (reference paper 1 and 2). The brightness measurements were made with the instrument Color Tech, supplied by Technidyne, Inc. The optical properties were measured according to ISO EN 12625-7. Results of the brightness measurements on the reference paper (ISO brightness, D65 UV Included, D65 UV Excluded and D65 10 FWA) are shown in Table 1A. The latter data is the delta between UV included and UV excluded and is a measure of the content of FWA in the reference paper. For comparison, the D65 10 FWA value for tissue paper made of virgin pulp is about 0, whereas the D65 10 FWA value for tissue paper made of recycled office paper is 8-16.

TABLE 1A
Brightness data for reference paper.

| | Reference paper 1 | Reference paper 2 |
|---|---|---|
| ISO Brightness | 73.8 | 76.1 |
| D65 10 UV included | 79.7 | 82.4 |
| D65 10 UV excluded | 68.1 | 70.7 |
| D65 10 FWA (Δ UV incl.-UV excl.) | 11.6 | 11.7 |

Two sheets of the above mentioned recycled dry creped tissue paper having a size 15×20 cm were prepared for glue gravure printing. As glue for the glue gravure printing, the polyvinyl alcohol glue Kappasil 260, supplied by Kapp-Chemie GmbH (Miehlen, Germany), was utilized. It was diluted with water in order to prepare a reference glue solution having a concentration of 6%. The reference glue solution was provided with 0.4% of violet ink concentrate Kappaflex P1/10063, supplied by Kapp-Chemie GmbH (Miehlen, Germany), in order to make the glue print visible on the tissue paper, i.e. Kappaflex P1/10063 was utilized as a marker. As mentioned above, the concentrations of substances provided herein are expressed in weight percentage (% w/w). Unless otherwise stated, these concentrations are measured as dry weights.

Glue gravure printing was performed by means of a “Labratester automatic”, supplied by Norbert Schläfli Machinen (Zofingen, Switzerland). A standard gravure printing plate having areas corresponding to gravure volumes of 0.7 ml/m², 3.7 ml/m², 6.8 ml/m², 10.3 ml/m² and 13 ml/m², respectively, was utilized. The size of each area was 2.5×12 cm.

About 1 ml of the reference glue solution was applied onto the gravure printing plate for printing each of the sheets. Each sheet was printed twice in order to simulate the amount of glue applied in a tissue lamination process where a gravure anilox roll of typically 20-25 ml/m² is used for the glue transfer. After the gravure printing, each sheet was folded once such that a folded sheet was formed with the glue print on the inside. Each sheet was folded such that regions being printed with the same gravure volume were joined. Thus, each sheet was folded such that a part of the area being printed with the gravure volume 0.7 ml/m² was joined with another part of the area being printed with the gravure volume 0.7 ml/m², such that a part of the area being printed with the gravure volume 3.7 ml/m² was joined with another part of the area being printed with the gravure volume 3.7 ml/m², etc. Samples of 2×5 cm were then punched out from the parts of the folded sheets comprising the respectively printed areas. Accordingly, simulated two-ply tissue products were then formed comprising two paper samples of 2×5 cm, which were printed with the same gravure volume and which were joined such that the glue print was provided on the inside, i.e. between the two plies. Thereby, simulated two-ply tissue products with glue prints corresponding to gravure volumes of 0.7 ml/m², 3.7 ml/m², 6.8 ml/m², 10.3 ml/m² and 13 ml/m², respectively, were prepared in Example 1. From each printed sheet one simulated product was prepared for each gravure volume. Since two sheets were utilized, two simulated products were prepared for each gravure volume.

FWA bleed fastness of the simulated two-ply tissue products was thereafter evaluated, partly in accordance with EN648 procedure B. The simulated products were brought into contact with glass fibre papers, which had been saturated with water. The glass fibre papers had a size of 60×90 mm and a basis weight of 70 gsm. One glass fibre paper was positioned on each side of a simulated product, and the glass fibre papers and the simulated product were placed under a load of 1 kg for 10 minutes. If any bleeding occurred, FWAs were then transferred to the glass fibre papers. The staining of the glass fibre papers, i.e. the amount of FWAs that had been transferred to the glass fibre papers, was then evaluated by analyzing the fluorescence of the glass fibre papers under UV-light.

According to EN648 procedure B, the fluorescence of the glass fibre papers is to be evaluated by comparison with a series of fluorescent whitened comparison papers. A comparison scale of 1-5 is to be utilized according to EN648 procedure B for reporting the results. The grade 1 means that a high bleeding has occurred, whereas the grade 5 means that no bleeding at all, or essentially no bleeding, has occurred. It should be noted that faint fluorescence (small bright spots) should not be determined as bleeding of FWAs according to EN648 procedure B. This is because faint fluorescence may be caused by other components in the paper, at the edges of the sample or from dust in the air. Therefore, fluorescence less than corresponding with grade 4 is not an indication of bleeding of FWAs and shall be evaluated as grade 5.

However, since the evaluation of the fluorescence according to EN648 procedure B is a highly subjective procedure, i.e. the assignment of the respective grades (1-5) to the respective simulated two-ply products depends on the person performing the evaluation, the fluorescence of the glass fibre papers was not evaluated in Example 1 by the subjective procedure according to EN648 procedure B. Instead the fluorescence was firstly evaluated by analyzing greyscale intensity by image analysis and the grey scale intensity values were then converted to a grade according to EN648 procedure B by means of the conversions according to Table 1C (this will be further described below). Thereby the subjective procedure was eliminated. Thus, FWA bleed fastness of the simulated two-ply tissue products was evaluated in Example 1 in accordance with EN648 procedure B except for the fact that the fluorescence of the glass fibre papers was not evaluated by the subjective procedure, but with greyscale intensity analysis and conversion of the greyscale intensity values by means of Table 1C.

For greyscale intensity analysis, the glass fibre papers were placed 45 cm below UV-lamps providing UV-A-light (365 nm) in a closed UV-light cabinet (i.e. the glass fibre papers were screened from other light). Images of the glass fibre papers were taken during the UV-light exposure with a Canon Powershot A620 digital camera. The camera was placed on top of the UV-light cabinet right above the glass fibre papers and images were taken through a 50 mm diameter opening at a distance of 50 cm from the glass fibre papers. In order to obtain usable images in the dark surroundings, the largest diaphragm opening of 2.8, a long shutter time of ¼ seconds and an ISO sensitivity of 100 were utilized. Images were then converted to greyscale with Image Pro-Plus 3.0 image analysis software, and greyscale intensity of the lightest part, corresponding to an area of 10×30 mm, of the glass fibre papers was recorded. By means of this procedure, a more objective and more sensitive evaluation of the intensity of the fluorescence was obtained. Greyscale values between 1 and 255 were utilized. The greyscale value “1” means black and the greyscale value “255” means white. Thus, a high greyscale value means that high bleeding has occurred, whereas a low greyscale value means that low or no bleeding at all has occurred. The results of the greyscale intensity evaluation are shown in Table 1B.

The procedure utilized for the FWA bleed fastness test resulted in two glass fibre papers to be evaluated for each simulated product. In addition, since two simulated products were prepared for each gravure volume, the FWA bleed fastness test resulted in four glass fibre papers for each utilized gravure volume. The greyscale intensity values shown in Table 1B for the respective simulated products are a mean value of the greyscale intensity of the four glass fibre papers associated with the respective simulated products.

In order to report the results of the FWA bleed fastness test with the grades 1-5 of the comparison scale according to EN648 procedure B described above, but with elimination of the subjective assignment of the respective grades to the respective simulated two-ply products, the greyscale intensity values were converted to the comparison grades 1-5 utilized in EN648 procedure B by utilizing the conversions according to Table 1C. The converted FWA bleed fastness grades (1-5) are reported in Table 1B. For example, in case a simulated product was determined to have a greyscale intensity of <25, the product was assigned grade “5” according to the comparison scale utilized in EN648 procedure B. In case a simulated product was determined to have a greyscale intensity of 25-34, the product was assigned grade “4” according to the comparison scale, etc.

In addition, the FWA bleed fastness was also determined for two simulated two-ply products without any glue. These products were respectively prepared by joining two samples of the above described recycled dry creped tissue paper having a size 2×5 cm. However, these samples were not provided with any glue. The FWA bleed fastness was then evaluated according to the above procedure and the results are shown in Table 1B.

TABLE 1B
FWA bleed fastness at bonding points of simulated two-ply products
comprising plies being lab gravure printed with the reference glue solution.

| | Greyscale | FWA bleed |
|---|---|---|
| Glue print of the plies of the simulated product | Intensity | fastness (1-5) |
| No glue | 21 | 5 |
| 0.7 ml/m² glue print | 35 | 3 |
| 3.7 ml/m² glue print | 82 | 2 |
| 6.8 ml/m² glue print | 111 | 1 |
| 10.3 ml/m² glue print | 131 | 1 |
| 13 ml/m² glue print | 139 | 1 |

TABLE 1C
Conversion of greyscale intensity to
FWA bleed fastness grades

| | FWA bleed fastness |
|---|---|
| Greyscale intensity | (1-5) |
| <25 | 5 |
| 25-34 | 4 |
| 35-49 | 3 |
| 50-89 | 2 |
| >89 | 1 |

For further FWA bleed fastness testing, it was decided to utilize gravure printing with 13.0 ml/m² twice. This print was chosen since it is an amount of glue that is realistic to utilize when laminating two plies to a multi-ply web.

### Example 2

### Objective

The objective of Example 2 was to test the FWA bleed fastness of sheets being glue gravure printed with an adhesive composition comprising polyvinyl alcohol, a polyaldehyde and an acid catalyst.

### Materials and Methods

In Example 2 the same recycled dry creped tissue paper as in Example 1 was utilized. Sheets of the recycled dry creped tissue paper having a size 15×20 cm were prepared for glue gravure printing.

Three different adhesive compositions (denoted adhesive compositions I, II and III) comprising polyvinyl alcohol, a polyaldehyde and an acid catalyst were prepared according to the following:

Adhesive Composition I: Pure and Fully Hydrolysed Polyvinyl Alcohol with 10% Polyaluminium Chloride and 0.22% Glyoxal
99% hydrolyzed polyvinyl alcohol without additives (Kappasil P4/447, Kapp-Chemie GmbH, Germany) was diluted with water to a concentration of 8%. 31.25 g of the produced 8% aqueous solution of 99% hydrolyzed polyvinyl alcohol was mixed with 0.275 g 40% glyoxal (Glyoxal 40%, BASF, Germany), whereby an intermediate adhesive composition was obtained. The intermediate adhesive composition was thereafter provided with 0.25 g of violet ink concentrate (Kappaflex P1/10063, Kapp-Chemie GmbH, Germany), 5 g polyaluminium chloride (PLUSPAC S 1800, Feralco Nordic AB, Sweden) and 13.225 g water, and mixed, whereby adhesive composition I was obtained.

Adhesive Composition II: Pure and Fully Hydrolysed Polyvinyl Alcohol with 8% Polyaluminium Chloride and 0.38% Glyoxal
99% hydrolyzed polyvinyl alcohol without additives (Kappasil P4/447, Kapp-Chemie GmbH, Germany) was diluted with water to a concentration of 8%. 31.25 g of the produced 8% aqueous solution of 99% hydrolyzed polyvinyl alcohol was mixed with 0.475 g 40% glyoxal (Glyoxal 40%, BASF, Germany), whereby an intermediate adhesive composition was obtained. The intermediate adhesive composition was thereafter provided with 0.25 g of violet ink concentrate (Kappaflex P1/10063, Kapp-Chemie GmbH, Germany), 4 g polyaluminium chloride (PLUSPAC S 1800, Feralco Nordic AB, Sweden) and 14.025 g water, and mixed, whereby adhesive composition II was obtained.

Adhesive Composition III: Pure and Fully Hydrolysed Polyvinyl Alcohol with 6% Polyaluminium Chloride and 0.38% Glyoxal
99% hydrolyzed polyvinyl alcohol without additives (Kappasil P4/447, Kapp-Chemie GmbH, Germany) was diluted with water to a concentration of 8%. 31.25 g of the produced 8% aqueous solution of 99% hydrolyzed polyvinyl alcohol was mixed with 0.475 g 40% glyoxal (Glyoxal 40%, BASF, Germany), whereby an intermediate adhesive composition was obtained. The intermediate adhesive composition was thereafter provided with 0.25 g of violet ink concentrate (Kappaflex P1/10063, Kapp-Chemie GmbH, Germany), 3 g polyaluminium chloride (PLUSPAC S 1800, Feralco Nordic AB, Sweden) and 15.025 g water, and mixed, whereby adhesive composition III was obtained.

In Example 2 sheets of the recycled dry creped tissue paper were gravure printed by means of a “Labratester automatic” and a standard gravure printing plate according to the procedure described in Example 1. Thus, 1 ml of adhesive composition was applied onto the gravure printing plate for printing one of the prepared sheets of the recycled dry creped tissue paper and each sheet was printed twice. One sheet was printed for each of the above described adhesive compositions denoted I-III, i.e. one sheet was printed with the adhesive composition I, one sheet was printed with the adhesive composition II and one sheet was printed with the adhesive composition III.

After the gravure printing, one sample of 2×5 cm was punched out from each sheet at the area of 13.0 ml/m² glue print. Thus, one one-ply sample being printed with 13.0 ml/m² on one side was formed from each sheet. Accordingly, one one-ply sample being printed with 13.0 ml/m² was formed for each of the adhesive compositions I-III. The prepared glue printed one-ply samples were dried in 105° C. in an oven for 5 minutes.

The FWA bleed fastness of the glue printed one-ply samples was in Example 2 evaluated in the same way as in Example 1, i.e. partly in accordance with EN648 procedure B. Thus, the glue-printed one-ply samples were brought into contact with water saturated glass fibre papers according to the procedure in Example 1, i.e. one glass fibre paper was positioned on each side of a sample, and the glass fibre papers and the sample were placed under a load of 1 kg for 10 minutes. Thereafter, the fluorescence of the glass fibre papers was evaluated by analyzing greyscale intensity according to the procedure for greyscale intensity analysis in Example 1. The results of the experiments in Example 2 are shown in Table 2. The procedure utilized for the FWA bleed fastness test resulted in two glass fibre papers to be evaluated for each glue printed one-ply sample. The greyscale intensity values shown in Table 2 for the respective glue printed one-ply samples are a mean value of the greyscale intensity of the two glass fibre papers associated with the respective glue printed one-ply samples. The FWA bleed fastness test was performed at room temperature.

In addition, the greyscale intensity values were converted to the comparison grades 1-5 utilized in EN648 procedure B in accordance with the procedure in Example 1, i.e. by utilizing the conversions in Table 1C.

Thus, FWA bleed fastness of the one-ply samples was evaluated in Example 2 in accordance with EN648 procedure B except for the fact that the fluorescence of the glass fibre papers was not evaluated by the subjective procedure according to EN648 procedure B, but with greyscale intensity analysis and conversion of the greyscale intensity values by means of Table 1C.

TABLE 2
FWA bleed fastness of one-ply samples being gravure printed
with the adhesive compositions denoted I-III.

| | | FWA bleed fastness |
|---|---|---|
| Utilized adhesive composition | Greyscale Intensity | (1-5) |
| Adhesive composition I | 13 | 5 |
| Adhesive composition II | 14 | 5 |
| Adhesive composition III | 17 | 5 |

### Conclusions

When comparing the results of the FWA bleed fastness tests shown in Tables 1B and 2, it is realized that the incorporation of a polyaldehyde and an acid catalyst in a polyvinyl alcohol glue results in a significant improvement of the FWA bleed fastness.

### Example 3

### Objective

The objective of Example 3 was to test the FWA bleed fastness of sheets being glue gravure printed with an adhesive composition comprising polyvinyl alcohol, a polyaldehyde and an acid catalyst.

### Materials and Methods

In Example 3 the same recycled dry creped tissue paper as in Example 1 was utilized. Sheets of the recycled dry creped tissue paper having a size 15×20 cm were prepared for glue gravure printing.

Four different adhesive compositions (denoted adhesive composition IV, V, VI and VII) comprising polyvinyl alcohol, a polyaldehyde and an acid catalyst were prepared according to the following:

Adhesive Composition IV: Polyvinyl Alcohol Glue Cross-Linked with Glyoxal and Sulphuric Acid as Catalyst
The polyvinyl alcohol glue Kappasil 260, supplied by Kapp-Chemie GmbH (Miehlen, Germany), was diluted with water to a concentration of 8%. 31.25 g of the produced 8% aqueous solution of Kappasil 260 was mixed with 0.3125 g 40% glyoxal (Glyoxal 40%, BASF, Germany), whereby an intermediate adhesive composition was obtained. The intermediate adhesive composition was thereafter provided with 0.25 g of violet ink concentrate (Kappaflex P1/10063, Kapp-Chemie GmbH, Germany), 1 g 25% sulphuric acid and 17.1875 g water, and mixed, whereby adhesive composition IV was obtained.

Adhesive Composition V: Polyvinyl Alcohol Glue Cross-Linked with Polyaldehyde Dextran and Sulphuric Acid as Catalyst
Firstly, polyaldehyde dextran was produced by hydrolyzing dialdehyde starch in sulphuric acid and heat. 15 g dialdehyde starch (DAS 100, Lyckeby Industrial AB, Sweden) was diluted with 15 g water. The produced aqueous solution was provided with 30 g of 50% sulphuric acid, after which it was positioned in 95° C. for about 2 hours. Thereafter, the dialdehyde starch had been hydrolyzed to polyaldehyde dextran.
Secondly, the polyvinyl alcohol glue Kappasil 260, supplied by Kapp-Chemie GmbH (Miehlen, Germany), was diluted with water to a concentration of 8%. 31.25 g of the produced 8% aqueous solution of Kappasil 260 was mixed with 2.0 g of the 25% polyaldehyde dextran described above, whereby an intermediate adhesive composition was obtained. The intermediate adhesive composition was thereafter provided with 0.25 g of violet ink concentrate (Kappaflex P1/10063, Kapp-Chemie GmbH, Germany), 1 g 25% sulphuric acid and 15.5 g water, and mixed, whereby adhesive composition V was obtained.

Adhesive Composition VI: 99% Hydrolyzed Polyvinyl Alcohol Cross-Linked with Glyoxal and Polyaluminium Chloride as Catalyst
99% hydrolyzed polyvinyl alcohol (Polyvinyl alcohol, 99% hydrolyzed, Scientific Polymer Products Inc., Ontario, the US, catalogue # 361) was diluted with water to a concentration of 10%. 25.0 g of the produced 10% aqueous solution of 99% hydrolyzed polyvinyl alcohol was mixed with 0.625 g 40% glyoxal (Glyoxal 40%, BASF, Germany), whereby an intermediate adhesive composition was obtained. The intermediate adhesive composition was thereafter provided with 0.25 g of violet ink concentrate (Kappaflex P1/10063, Kapp-Chemie GmbH, Germany), 4 g polyaluminium chloride (PLUSPAC S 1800, Feralco Nordic AB, Sweden) and 20.125 g water, whereby adhesive composition VI was obtained.

Adhesive Composition VII: Polyvinyl Alcohol Glue Cross-Linked with Glyoxal and Polyaluminium Chloride as Catalyst
The polyvinyl alcohol glue Kappasil 260, supplied by Kapp-Chemie GmbH (Miehlen, Germany), was diluted with water to a concentration of 8%. 31.25 g of the produced 8% aqueous solution of Kappasil 260 was mixed with 0.625 g 40% glyoxal (Glyoxal 40%, BASF, Germany), whereby an intermediate adhesive composition was obtained. The intermediate adhesive composition was thereafter provided with 0.25 g of violet ink concentrate (Kappaflex P1/10063, Kapp-Chemie GmbH, Germany), 7.5 g polyaluminium chloride (PLUSPAC S 1800, Feralco Nordic AB, Sweden) and 10.375 g water, whereby adhesive composition VII was obtained.

In Example 3 sheets of the recycled dry creped tissue paper were gravure printed by means of a “Labratester automatic” and a standard gravure printing plate according to the procedure described in Example 1. Thus, 1 ml of adhesive composition was applied onto the gravure printing plate for printing one of the prepared sheets of the recycled dry creped tissue paper and each sheet was printed twice. One sheet was printed for each of the above described adhesive compositions denoted IV-VII, i.e. one sheet was printed with the adhesive composition IV, one sheet was printed with the adhesive composition V, one sheet was printed with the adhesive composition VI and one sheet was printed with the adhesive composition VII.

After the gravure printing, one sample of 2×5 cm was punched out from each sheet at the area of 13.0 ml/m² glue print. Thus, one one-ply sample being printed with 13.0 ml/m² on one side was formed from each sheet. Accordingly, one one-ply sample being printed with 13.0 ml/m² was formed for each of the adhesive compositions IV-VII. The prepared one-ply samples printed with adhesive compositions VI and VII were dried in 105° C. in an oven for 5 minutes.

The FWA bleed fastness of the glue printed one-ply samples in Example 3 was evaluated in the same way as in Example 1, i.e. partly in accordance with EN648 procedure B. Thus, the glue-printed one-ply samples were brought into contact with water saturated glass fibre papers according to the procedure for greyscale intensity analysis in Example 1, i.e. one glass fibre paper was positioned on each side of a sample, and the glass fibre papers and the sample was placed under a load of 1 kg for 10 minutes. Thereafter, the fluorescence of the glass fibre papers was evaluated by analyzing greyscale intensity according to the procedure in Example 1. The results of the experiments in Example 3 are shown in Table 3. The procedure utilized for the FWA bleed fastness test resulted in two glass fibre papers to be evaluated for each glue printed one-ply sample. The greyscale intensity values shown in Table 3 for the respective glue printed one-ply samples are a mean value of the greyscale intensity of the two glass fibre papers associated with the respective glue printed one-ply samples. The FWA bleed fastness test was performed at room temperature.

In addition, the greyscale intensity values were converted to the comparison grades 1-5 utilized in EN648 procedure B in accordance with the procedure in Example 1, i.e. by utilizing the conversions in Table 1C.

Thus, FWA bleed fastness of the one-ply samples was evaluated in Example 3 in accordance with EN648 procedure B except for the fact that the fluorescence of the glass fibre papers was not evaluated by the subjective procedure according to EN648 procedure B, but with greyscale intensity analysis and conversion of the greyscale intensity values by means of Table 1C.

TABLE 3
FWA bleed fastness of one-ply samples being gravure printed with
the adhesive compositions denoted IV-VII.

| | | FWA bleed fastness |
|---|---|---|
| Utilized adhesive composition | Greyscale intensity | (1-5) |
| Adhesive composition IV | <21 | 5 |
| Adhesive composition V | <21 | 5 |
| Adhesive composition VI | <21 | 5 |
| Adhesive composition VII | <21 | 5 |

### Conclusions

When comparing the results of the FWA bleed fastness tests shown in Tables 1B and 3, it is realized that the incorporation of a polyaldehyde and an acid catalyst in a polyvinyl alcohol glue results in a significant improvement of the FWA bleed fastness.

Thus, while there have been described and pointed out fundamental novel features of the invention as applied to preferred embodiments thereof, it will be understood that various omissions and substitutions and changes in the form and details of the products and method steps described may be made by those skilled in the art. For example, it is expressly intended that all combinations of those elements and/or method steps which perform substantially the same function in substantially the same way to achieve the same results are within the scope of the invention. Moreover, it should be recognized that structures and/or elements and/or method steps described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-26. (canceled)

27. A multi-ply web of flexible material, such as tissue paper or nonwoven material, said flexible material comprising a fluorescent whitening agent, whereby the multi-ply web comprises at least a first ply and a second ply which are interconnected in one or more adhesive interconnection zones by means of an adhesive composition comprising polyvinyl alcohol,
wherein said adhesive composition further comprises a polyaldehyde and an acid catalyst, whereby said polyvinyl alcohol is cross-linked with said polyaldehyde such that said adhesive composition is water insoluble.

28. The multi-ply web according to claim 27, wherein said multi-ply web further comprises a third ply, whereby said second and third plies are interconnected in one or more adhesive interconnection zones by means of said adhesive composition.

29. The multi-ply web according to claim 27, wherein said polyaldehyde is a dialdehyde.

30. The multi-ply web according to claim 29, wherein said dialdehyde is glyoxal or glyoxal hydrate.

31. The multi-ply web according to claim 27, wherein said polyaldehyde is polyaldehyde dextran.

32. The multi-ply web according to claim 27, wherein said acid catalyst is selected from the group consisting of: polyaluminium chloride, polyferric sulphate, polyferric chloride, ferric chloride sulphate, polysilicate aluminium sulphate, polyferric silicate sulphate, polyaluminium silicate chloride, polyaluminium ferric silicate chloride, polyferric chloride sulphate, and polyaluminium ferric chloride.

33. The multi-ply web according to claim 27, wherein said flexible material comprises recycled flexible material.

34. The multi-ply web according to claim 27, wherein said flexible material is a tissue paper to which a wet strength agent has been added.

35. A method for improving the bleed fastness of a fluorescent whitening agent of a multi-ply web of flexible material, such as tissue paper or nonwoven material, comprising a fluorescent whitening agent, said multi-ply web comprising at least a first ply and a second ply being interconnected in one or more adhesive interconnection zones by means of an adhesive composition comprising polyvinyl alcohol,
wherein the method comprises a step of incorporating a polyaldehyde and an acid catalyst in said adhesive composition comprising polyvinyl alcohol so as to cross-link said polyvinyl alcohol with said polyaldehyde such that said adhesive composition is made water insoluble.

36. The method according to claim 35, wherein said multi-ply web further comprises a third ply, whereby said second and third plies are interconnected in one or more adhesive interconnection zones by means of said adhesive composition.

37. The method according to claim 35, wherein the step of incorporating a polyaldehyde and an acid catalyst in said adhesive composition is performed before plies of the multi-ply web are interconnected by means of the adhesive composition.

38. The method according to claim 37, wherein the step of incorporating a polyaldehyde and an acid catalyst in said adhesive composition is performed before application of the adhesive composition on a ply of flexible material for interconnection with another ply of flexible material.

39. The method according to claim 35 wherein the method further comprises a step of heating said adhesive composition to 65-110° C. after said incorporation so as to promote said cross-linking.

40. The method according to claim 35, wherein said adhesive composition comprises 0.05-2.00% w/w polyaldehyde, after said step of incorporation of a polyaldehyde and an acid catalyst but before any cross-linking has occurred.

41. The method according to claim 35, wherein said polyaldehyde is a dialdehyde.

42. The method according to claim 41, wherein said dialdehyde is glyoxal or glyoxal hydrate.

43. The method according to claim 42, wherein said adhesive composition comprises 0.10-0.50% w/w glyoxal, after said step of incorporation of a polyaldehyde and an acid catalyst but before any cross-linking has occurred.

44. The method according to claim 35, wherein said polyaldehyde is polyaldehyde dextran.

45. The method according to claim 44, wherein said adhesive composition comprises 0.10-1.00% w/w polyaldehyde dextran, after said step of incorporation of a polyaldehyde and an acid catalyst but before any cross-linking has occurred.

46. The method according to claim 35, wherein said adhesive composition comprises 2-12% w/w polyvinyl alcohol, after said step of incorporation of a polyaldehyde and an acid catalyst but before any cross-linking has occurred.

47. The method according to claim 35, wherein said acid catalyst is selected from the group consisting of: polyaluminium chloride, polyferric sulphate, polyferric chloride, ferric chloride sulphate, polysilicate aluminium sulphate, polyferric silicate sulphate, polyaluminium silicate chloride, polyaluminium ferric silicate chloride, polyferric chloride sulphate, and polyaluminium ferric chloride.

48. The method according to claim 35, wherein said adhesive composition comprises 0.30-20.00% w/w acid catalyst, after said step of incorporation of a polyaldehyde and an acid catalyst but before any cross-linking has occurred.

49. The method according to claim 35, wherein the flexible material comprises recycled flexible material.

50. The method according to claim 35, wherein said flexible material is a tissue paper to which a wet strength agent has been added.
